(19) United States
(12) Patent Application Publication
(10) Pub. No.: US 2009/0030535 A1
(43) Pub. Date: Jan. 29, 2009

(54) AUDIO PLAYBACK APPARATUS AND NETHID BASED ON A GENERAL SPI INTERFACE

(75) Inventor: Ming-Yao Yang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SOLID STATE SYSTEM CO., LTD., Hsinchu (TW)

(21) Appl. No.: 11/781,280

(22) Filed: Jul. 23, 2007

(51) Int. Cl. G06F 17/00

(52) U.S. Cl. 700/94

(57) ABSTRACT

An audio playback apparatus is based on a pre-defined data communication protocol, and communicating with an external host. The audio playback apparatus includes an audio playback engine, having a plurality of I/O pins based on the pre-defined data communication protocol for communicating with the external host. The pre-defined data communication protocol allows to transmit a communication information between the audio playback engine and the external host. In addition, an audio control command and an audio data stream defined in a pre-defined protocol are treated as the communication information between the audio playback engine and the external host.

### BACKGROUND OF THE INVENTION

1. Field of Invention

The present invention relates to audio playback technology. More particularly, the present invention relates to an audio playback apparatus based on a general serial peripheral interface (SPI).

2. Description of Related Art

Audio playback apparatus, such as MP3 playback engine, has been a very popular audio product for playing music. In the conventional apparatus, the control commands and the audio data stream are transmitted via control line and data line respectively. FIG. 1 is a block diagram, schematically illustrating a conventional mechanism to control the audio playback apparatus, such as MP3 players.

In FIG. 1, the MP3 10 as a playback apparatus 10 is controlled by a host 14 for audio data. However, another block 12 having I²C interface is used to input the control commands to the MP3 10.

Alternatively, other bus of I²S (Inter-IC Sound) has also been proposed. FIG. 2 is a block diagram, schematically illustrating the operation based on I²S bus. In FIG. 2, the playback apparatus 20 receives the audio data via the input unit 26. However, the playback apparatus 20, as a transmitter, is communicating with the master host 22, as a receiver, under control by a controller 24 based on the I²S bus. The I²S bus is a serial bus designed for digital audio devices and handles audio data separately from clock signals. The I²S bus usually includes the SCK line, Ws line, and SD line. The SD line has two time-division multiplexing (TDM) data channels. The WS line is a word select line and The SCK line is a clock line. Data is transmitted in two complements by MSB first. Data sent from the transmitter 20 may be synchronized with either the high-to-low or low-to-high transition of the clock [SCK], but the receiver 22 latches the data on the leading edge of the clock. The word select line WS indicates which channel is being transmitted. Channel 1 is indicated by WS=0, or channel 2 is indicated by WS=0. The I²S Bus uses standard TTL logic levels. Typical clock [SCK] is 2.5 MHz, maximum clock speed is 3.125 MHz. The WS line is sent one clock before the data is sent. One chip in the I²S Bus system generates a Master clock, while all other devices derive their internal clocks from this reference. Standard clock rates include: 32 KHz, 44.1 KHz, or 48 KHz [or multiples of these]. Data may be sent with MSB first or LSB first. The word length is adjustable up to 28 bits. Synchronization with the data words may also be set to either the rising or falling edge of the clock.

For the conventional audio control manners, the operation based on I²C needs two parts in control. Even though the operation based on I²S can be more efficiently control the playback apparatus. The art is still under developing for another manner for improving the playback performance.

### SUMMARY OF THE INVENTION

The invention provides an audio playback apparatus and method to play audio information, such as the music, based on the general SPI interface. As a result, the audio playback apparatus can communicate with external host via limited number of general I/O pins.

The invention provides an audio playback apparatus, based on a pre-defined data communication protocol and communicating with an external host. The audio playback apparatus includes an audio playback engine, having a plurality of I/O pins based on the pre-defined data communication protocol to communicate with the external host. The pre-defined data communication protocol allows to transmit a communication information between the audio playback engine and the external host. In addition, an audio control command and an audio data stream are treated as the communication information between the audio playback engine and the external host.

According to a further embodiment of the invention for the audio playback apparatus, the pre-defined data communication protocol comprises a serial peripheral interface (SPI) protocol for transmitting the audio control command and the audio data stream.

According to a further embodiment of the invention for the audio playback apparatus, the I/O pins comprise clock (CLK), chip select (CS), data in (DI), and data out (DO).

According to a further embodiment of the invention for the audio playback apparatus, the I/O pins further comprise ready busy and wake up (RY/#BY) and data stream request (#DataReq).

According to a further embodiment of the invention for the audio playback apparatus, the protocol comprises a general command, a write command, and a read command.

According to a further embodiment of the invention for the audio playback apparatus, each of the write command and the read command is a 4-byte size.

According to a further embodiment of the invention for the audio playback apparatus, each of the write command and the read command comprises a first byte to transmit a command content for a desired event, a second byte to transmit an event status of the desired event, at least one byte for confirmation.

According to a further embodiment of the invention for the audio playback apparatus, the pre-defined protocol further comprises a response command.

According to a further embodiment of the invention for the audio playback apparatus, the response command comprises a first byte to transmit a response content, a second byte to transmit an indicator information, and a third byte to transmit data.

The invention also provides a method for controlling an audio playback apparatus, based on a pre-defined data communication protocol, and communicating with an external host. The method comprises providing an audio playback engine, having a plurality of I/O pins based on the pre-defined data communication protocol for communicating with the external host. The pre-defined data communication protocol is defined for allowing transmitting a communication information between the audio playback engine and the external host. The communication information is used to transmit an audio control command and an audio data stream defined in a pre-defined protocol between the audio playback engine and the external host.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram, schematically illustrating a conventional mechanism to control the MP3 apparatus.

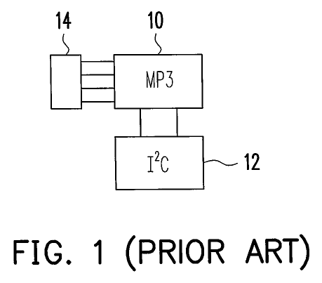

FIG. 2 is a block diagram, schematically illustrating the operation based on I²S bus.

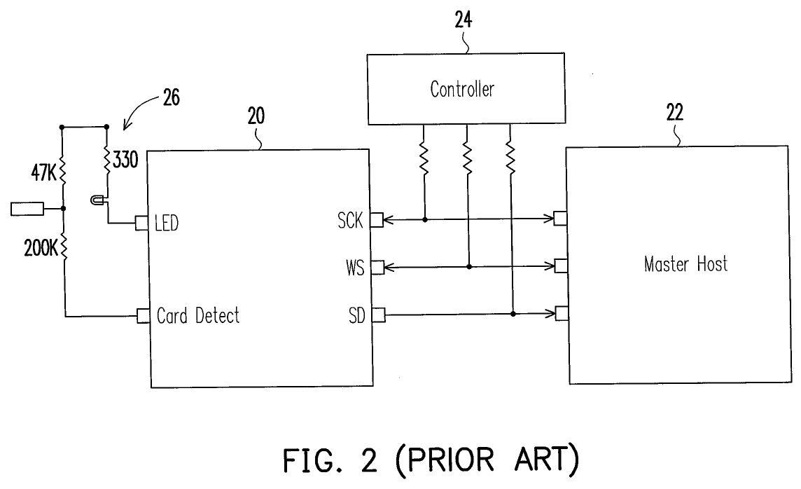

FIG. 3 is a block diagram, schematically illustrating an audio playback apparatus in communication with an external master host, according to a preferred embodiment of the invention.

### DESCRIPTION OF THE PREFERRED EMBODIMENTS

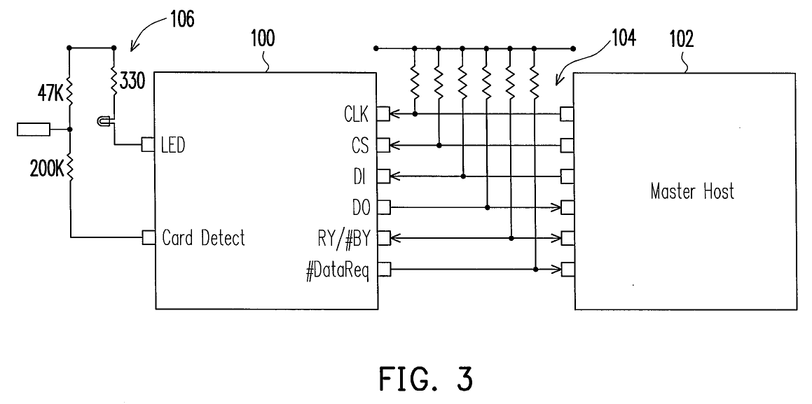

FIG. 3 is a block diagram, schematically illustrating an audio playback apparatus in communication with an external master host, according to a preferred embodiment of the invention. In the invention, as for example shown in FIG. 3, an audio playback apparatus 100, such as a MP3 controller, can at least play audio information, such as music. The audio playback apparatus 100 is communicating with an external master host 102 or an external micro-controller, so as to play the desired music. However, in the present invention, the audio playback apparatus 100 is designed to communicate with the master host 102 based on a general SPI protocol, so as to transmit data between the audio playback apparatus 100 and the master host 102 via the SPI bus 104. The audio playback apparatus 100 may also need to adapt a memory card, which stores the audio information, via the usual unit 106.

Since the SPI protocol is not originally used to control the audio playback apparatus 100 for playing audio information, such as the music, the needed commands for playing music should be further defined under a pre-defined protocol, so that the audio command and the audio data can be transmitted between the audio playback apparatus 100 and the master host 102.

Still in FIG. 3, the present invention assigns, for example, four I/O pins to transmit clock (CLK), chip select (CS), data-in (DI) and data-out (DO). If additional function is needed, then additional I/O pins are further assigned as, for example, ready busy and wake up (RY/#BY) and data stream request (#DataReq). In other words, the audio playback apparatus 100 can always use the four signal lines of CLK, CS, DI, and DO; and additional two signal lines of RY/#BY and #DataReq in option to communicate with master host 102 for play audio information by CLK, CS, DI, and DO. The signal lines of RY/#BY and #DataReq can eve further allow the master host to fetch some non-audio information, such as the descriptions about the music in playing.

The further operation mechanism is further described as follows. The SPI bus usually needs pull-up resistors to connect to the voltage source Vcc. The clock (CLK) is from the master host 102 to the slave device of the audio playback apparatus via the SPI bus 104 to control the data shift into or out from the audio playback apparatus 100. The clock can be up to 3 MHz. The chip select (CS) is an active-low slave select input and must be held low while writing data to or reading data from the audio playback apparatus 100. The chip select (CS) may also remain active low between successive transfers when system is a single fixed master and a single slave driving the data lines. The data in (DI) is the serial data input and is data valid on the rising edge of the clock (CLK). The data out (DO) is the serial data output and is data valid on the rising edge of the CLK. It should be noted that the synchronous serial data in the present invention are transferred by separating DI and DO pins. This can improve the efficiency for transferring serial data. The pin of RY/#BY is a status output to indicate that the current audio playback apparatus 100 is either ready or busy. When the RY/#BY pin is at logic high, it means that the audio playback apparatus 100 is ready to receive a command or data from the master host 102. When RY/#BY pin goes to logic low, it indicates that the audio playback apparatus 100 is in busy for receiving any command or data. This RY/#BY pin is also for wake-up function after sleep command is received by the audio playback apparatus 100 from the master host 102. In addition, the audio playback apparatus 100 can reply a signal, such as NAK (0x15), to the mater host 102 if the previous command or data is unknown to the audio playback apparatus 100. The #DataReq pin is implemented while the mater host 102 needs to send, i.e., MP3 data stream to the audio playback apparatus 100 and playback in the audio playback apparatus 100. Alternatively, the #DataReq pin can connect to an interrupt pin of the mater host 102 for a better system performance.

In the conventional way, the MP3 playback engine has the separate control line and data line, using I²C for controlling and the other data line for data stream. However, in the present invention, the system can use the same interface to combine the control line and the data line in single connection port based on the SPI protocol, for example. Then, by redefine the content of SPI protocol by the pre-defined protocol, several audio commands can be defined based on the SPI protocol.

In order to successfully transmit data between the audio playback apparatus 100 and the master host 102, several commands are defined based on a pre-defined protocol as an example to be described later. For stable and robust communication in SPI, for example, three kinds of command type can be defined for general command (STCMD), write command (WRCMD), and read command (RDCMD). Additionally, the response command (RSCMD) can also be defined. Basically, the general command (STCMD) is one byte command packet. The other commands of write command, read command, and response command can be, for example, 4-byte packet, so as to easily commit to 32-bit CPU system in software implementation. However, it does not always need to be 4-byte packet. Usually, the first bit is preferably set to “0” for the start bit in command byte, so as to avoid the noise from the system, causing invalid command. In addition, parts of RSCMD are a variable byte packet for master host to get MP3 file name, MP3 ID3 data and other information in need, for example. The format of each command is, for example, in shown in Tables as follows:

TABLE 1

| Bit | | | | | | | |
|---|---|---|---|---|---|---|---|
| 7 | 6 | 5 | 4 | 3 | 2 | 1 | 0 |

| | | | | | |
|---|---|---|---|---|---|
| Width | 1 | 1 | 1 | 1 | 4 |
| Value | 0 | 0 | 0 | 0 | X |
| Description | Start bit | RD | WR | Event | Command index |

In Table 1, it is the definition for the general command (STCMD) in one byte packet.

The write command is in, for example, 4-byte packet.

TABLE 2

| Bit | | | | | | | |
|---|---|---|---|---|---|---|---|
| 7 | 6 | 5 | 4 | 3 | 2 | 1 | 0 |

| | | | | | |
|---|---|---|---|---|---|
| Width | 1 | 1 | 1 | 1 | 4 |
| Value | 0 | 0 | 1 | X | X |
| Description | Start bit | RD | WR | Event | Command index |

TABLE 3

| Bit | | | | | | | |
|---|---|---|---|---|---|---|---|
| 7 | 6 | 5 | 4 | 3 | 2 | 1 | 0 |

| | | | | | | | |
|---|---|---|---|---|---|---|---|
| Width | 2 | 1 | 1 | 1 | 1 | 1 | 1 |
| Value | 0 | X | X | X | X | X | 0 |
| Description | Reserved | Sector | PlayFile | SysReset | PlayFolder | Sleep | Rsvd |

In Table 2, the write command (WRCMD) in one byte is defined. However, in order to make sure that the command is proper, the Event status in Table 3 with one byte is issued right after the write command in Table 2. Then, preferably, another two bytes for confirmation may be also issued after the Event status, for example. As a result, the full set of write command is in 4-byte packet.

The read command (RDCMD) in, for example, 4-byte packet is as follows:

TABLE 4

| Bit | | | | | | | |
|---|---|---|---|---|---|---|---|
| 7 | 6 | 5 | 4 | 3 | 2 | 1 | 0 |

| | | | | | |
|---|---|---|---|---|---|
| Width | 1 | 1 | 1 | 1 | 4 |
| Value | 0 | 1 | 0 | X | X |
| Description | Start bit | RD | WR | Event | Command index |

TABLE 5

| Bit | | | | | | | |
|---|---|---|---|---|---|---|---|
| 7 | 6 | 5 | 4 | 3 | 2 | 1 | 0 |

| | | | | | | |
|---|---|---|---|---|---|---|
| Width | 3 | 1 | 1 | 1 | 1 | 1 |
| Value | 0 | X | X | X | X | X |
| Des- | Reserved | Get-ID | Filename | ID3v2 | ID3v1 | Register |
| cription | | | | | | |

In Table 4, the read command in one byte is defined. However, in order to make sure that the command is proper, the Event status in Table 5 with one byte is issued right after the read command in Table 4. Then, preferably, another two bytes for confirmation may be also issued after the Event status, for example. As a result, the full set of read command is in 4-byte packet.

The response command (RSCMD) in, for example, variable byte packet is as follows:

TABLE 6

| | Bit | | | | | | | |
|---|---|---|---|---|---|---|---|---|
| | 7 | 6 | 5 | 4 | 3 | 2 | 1 | 0 |
| Width | 1 | 1 | 1 | 1 | 1 | 1 | 1 | 1 |
| Value | 0 | X | X | X | X | X | X | X |
| Description | Start-Bit | Indicator | Sector | Error | Play | Event | Pause | Stop |

TABLE 7

| Bit | | | | | | | |
|---|---|---|---|---|---|---|---|
| 7 | 6 | 5 | 4 | 3 | 2 | 1 | 0 |

| | |
|---|---|
| Width | 8 |
| Value | 0x0-0xFF |
| Description | Indicator Length (i.e. Max = 255 byte) |

TABLE 8

| Bit | | | | | | | |
|---|---|---|---|---|---|---|---|
| 7 | 6 | 5 | 4 | 3 | 2 | 1 | 0 |

| | | |
|---|---|---|
| Width | 1 | 7 |
| Value | X | 0x1-0x7F(i.e. Max is 127 sectors |
| | | where bit 7 is 0) |
| Description | Plus One count | Max bytes is (127 + 1) * |
| | | 512 = 65536 bytes where bit 7 is 1 |

In Table 6, the response command is defined in one byte. Then, the indicator referring to bit 6 is further defined. In one case, the indicator is defined in Table 7 for general situation. However, if the sector bit (bit 5) is set in the response command, then the indicator is in different format as shown in Table 8. As previously stated, the full set of response command may be not just 4-byte packet, due to some additional information is to be communicated. Therefore, the response command can be variable packet.

In general, based on three types of commands of STCMD, WRCMD, and RDCMD with the RSCMD in a pre-defined protocol, master host can read many i.e. MP3 information and set the configuration in need. In addition to Read/Write and control by SPI protocol, the SPI pre-defined protocol is proposed to play the audio information, such as MP3 audio data stream. The audio playback apparatus of the present invention can play MP3 data stream up to 128 Kbps while the clock (CLK) is at 3 MHz. It should be noted that the above examples are just for descriptions. The present invention is not limited to the examples. The audio data is not limited to MP3 data stream. In addition, since the audio playback apparatus of the present invention uses the general SPI interface, the audio playback apparatus is easily communicating with master host without limitation by the conventional manner in control pins and data pins. The audio playback apparatus can be easily adapted by various systems.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An audio playback apparatus, based on a general SPI interface and a pre-defined data communication protocol, to communicate with an external host, comprising:
an audio playback engine, having a plurality of I/O pins based on the general SPI communication protocol for communicating with the external host,
wherein the pre-defined data communication protocol allows the apparatus to transmit a communication information between the audio playback engine and the external host, wherein the communication information between the audio playback engine and the external host contains an audio control command or an audio data stream or both control command and audio data stream.

2. The audio playback apparatus of claim 1, wherein the audio playback engine comprises a MP3 decoder or a WMA decoder.

3. The audio playback apparatus of claim 1, wherein the I/O pins comprise clock (CLK), chip select (CS), data in (DI), and data out (DO).

4. The audio playback apparatus of claim 3, wherein the I/O pins further comprise ready busy and wake up (RY/#BY) and data stream request (#DataReq).

5. The audio playback apparatus of claim 1, wherein the pre-defined protocol comprises a control command, a write command, and a read command.

6. The audio playback apparatus of claim 5, wherein each of the write command and the read command is a 4-byte size.

7. The audio playback apparatus of claim 5, wherein each of the write command and the read command comprises a first byte to transmit a command content for a desired event, a second byte to transmit an event status of the desired event, at least one byte for confirmation.

8. The audio playback apparatus of claim 5, wherein the pre-defined protocol further comprises a response command.

9. The audio playback apparatus of claim 8, wherein the response command comprises a first byte to transmit a response content, a second byte to transmit an indicator information, and a third byte to transmit data.

10. A method for controlling an audio playback apparatus, based on a general SPI interface and a pre-defined data communication protocol, to communicate with an external host,
comprising:
providing an audio playback engine, having a plurality of I/O pins based on the pre-defined data communication protocol for communicating with the external host;
defining the pre-defined data communication protocol in allowing transmitting a communication information between the audio playback engine and the external host;
using the communication information to transmit an audio control command and an audio data stream defined between the audio playback engine and the external host.

11. The audio playback method of claim 10, wherein the audio playback engine comprises a MP3 decoder or(and?) a WMA decoder.

12. The audio playback method of claim 10, wherein the I/O pins comprise clock (CLK), chip select (CS), data in (DI), and data out (DO).

13. The audio playback method of claim 12, further comprising defining a ready busy and wake up (RY/#BY) and a data stream request (#DataReq).

14. The audio playback method of claim 10, further comprising the pre-defined protocol to have a general command, a write command, and a read command.

15. The audio playback method of claim 14, wherein each of the write command and the read command is a 4-byte size.

16. The audio playback method of claim 14, wherein each of the write command and the read command comprises a first byte to transmit a command content for a desired event, a second byte to transmit an event status of the desired event, at least one byte for confirmation.

17. The audio playback method of claim 14, further defining the pre-defined protocol having a response command.

18. The audio playback method of claim 17, wherein the response command is defined to comprise a first byte to transmit a response content, a second byte to transmit an indicator information, and a third byte to transmit data.
